(19) United States
(12) Patent Application Publication
(10) Pub. No.: US 2025/0131008 A1
(43) Pub. Date: Apr. 24, 2025

(54) CLOUD AGNOSTIC GENERIC DERIVED ASSET SCANNER

(71) Applicant: VMware, Inc., Palo Alto, CA (US)

(72) Inventors: Bhavin D. SOPARIWALA, Shrewsbury, MA (US); Liam Andrew DOUGLASS, San Francisco, CA (US); Corban David MAILLOUX, Amherst, MA (US); Jared Austin HOWELL, Bothell, WA (US)

(21) Appl. No.: 18/491,201

(22) Filed: Oct. 20, 2023

(51) Int. Cl. G06F 16/25

(52) U.S. Cl. CPC G06F 16/258

(57) ABSTRACT

An example method of identifying resources deployed in clouds in a computing system includes: receiving, at an asset scanner executing in a data center, billing artifacts from the clouds, the billing artifacts relating resources deployed in the clouds with identification and usage information; transforming, by the asset scanner, the billing artifacts into transformed billing artifacts, each transformed billing artifact having entries that relate one of the resources to a selected portion of the identification and usage information; generating, by the asset scanner, a plurality of jobs to process the resources; and processing, by the asset scanner, the plurality of jobs to update a database that relates the resources and the selected portion of the identification and usage information.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtualized infrastructure is carried out by virtualization software, which includes hypervisors installed in the host computers (“virtualized hosts”) and management software for managing the virtualized hosts. The management software can include a network manager for managing a software defined network (SDN) in the SDDC.

A user's computing system can include multiple SDDCs deployed in one or more computing environments, which include public cloud(s), on-premises data centers, co-location data centers, and the like. In particular, a user can have many assets distributed across public clouds. It can be difficult to track these public cloud assets across different clouds. There can be a large number of public cloud assets and some public cloud assets can be created automatically unbeknownst to the user. It is desirable to track the provisioning, use, and deprovisioning of public cloud asserts in a computing system for purposes including cost control, performance monitoring, visibility, and the like.

### SUMMARY

In an embodiment, a method of identifying resources deployed in clouds in a computing system is described. The method includes receiving, at an asset scanner executing in a data center, billing artifacts from the clouds, the billing artifacts relating resources deployed in the clouds with identification and usage information; transforming, by the asset scanner, the billing artifacts into transformed billing artifacts, each transformed billing artifact having entries that relate one of the resources to a selected portion of the identification and usage information; generating, by the asset scanner, a plurality of jobs to process the resources; and processing, by the asset scanner, the plurality of jobs to update a database that relates the resources and the selected portion of the identification and usage information.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a computing system according to embodiments.

FIG. 2 is a block diagram depicting an SDDC according to embodiments.

FIG. 3 is a block diagram depicting G-DAS according to embodiments.

FIG. 4 is a block diagram depicting an artifact transformation according to embodiments.

FIG. 5 is a flow diagram depicting a method of deriving resources and resource utilization from billing artifacts from clouds according to embodiments.

### DETAILED DESCRIPTION

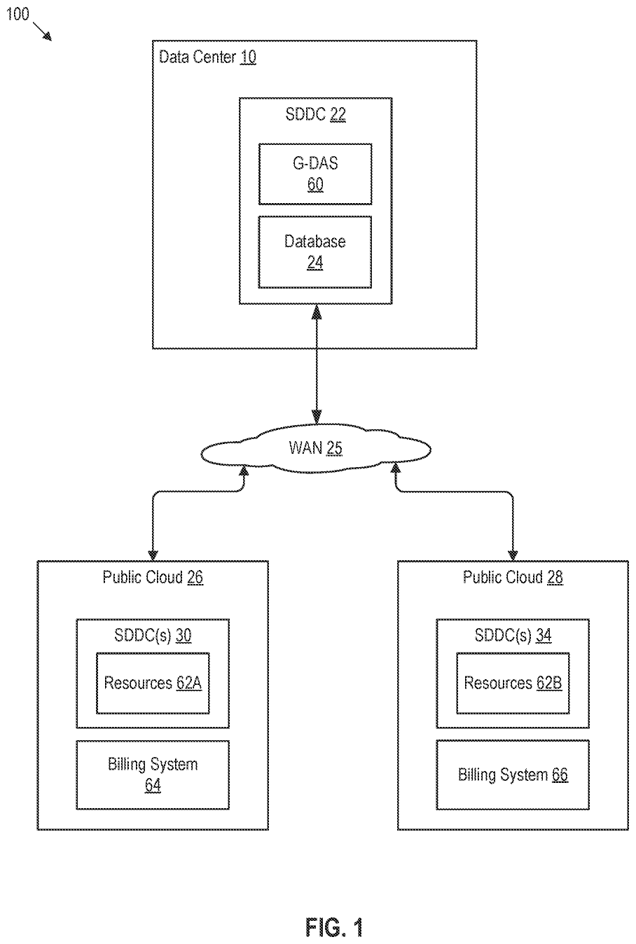

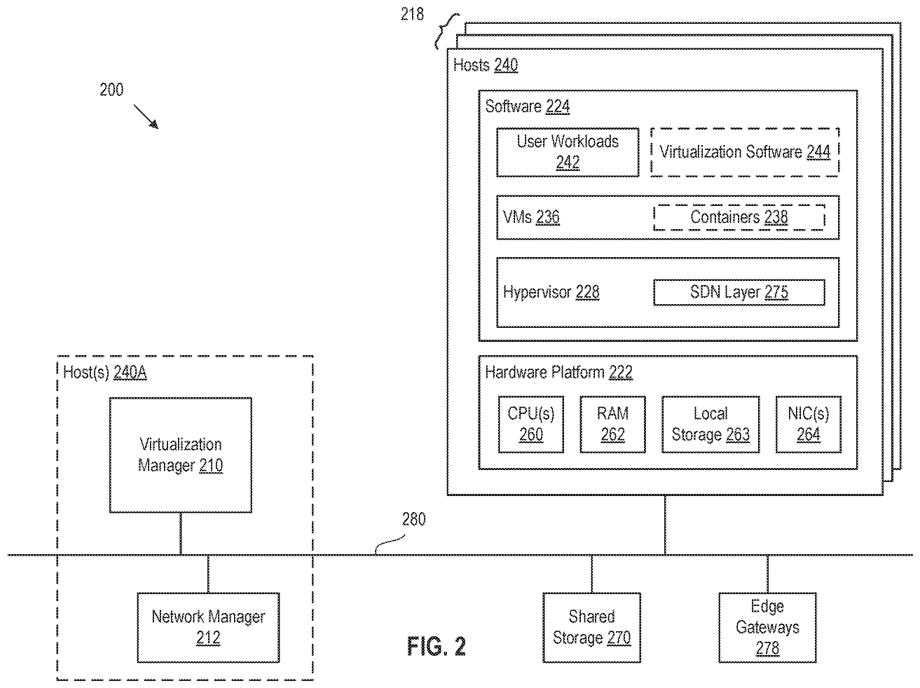

FIG. 1 is a block diagram depicting a computing system 100 according to embodiments. Computing system 100 comprises software executing on virtualized infrastructure disposed in one more cloud(s) and/or data center(s) (a “virtualized computing system”). Computing system 100 can be operated by a user, can include one or more SDDCs, and can be deployed in public cloud(s) and/or data center(s). In the example of FIG. 1, computing system 100 includes SDDC 22 deployed in a data center 10, SDDC 30 deployed in a public cloud 26, and SDDC 34 deployed in public cloud 28. The user operates data center 10 or is a customer of data center 10. The user is a customer of public clouds 26-28 (among other customers), where each can be operated by a different vendor. SDDC(s) 22, 26, and 28 are deployed on virtualized infrastructure (VI), which includes virtualized hosts (host computers having hypervisors installed thereon) and virtualization software (the hypervisors and management software). An example SDDC 200 deployed on VI is shown in FIG. 2 and described below. Components of computing system 100 deployed in different public cloud(s) and/or data center(s) communicate through a wide area network (WAN) 25, such as the public Internet.

A generic derived asset scanner (G-DAS) 60 executes in SDDC 22. A database 24 executes in SDDC 22 and stores data collected and generated by G-DAS 60. G-DAS 60 derives information about many resources deployed in public clouds from billing artifacts generated by the public clouds. In embodiments, this derivation allows the user to understand the cost associated with these resources and to categorize based on tag values. G-DAS 60 provides a framework to build resource derivation across different public clouds, which brings uniformity across clouds in terms of performance, visibility, monitoring, etc. Operation of G-DAS 60 is described below.

SDDC 30 includes resources 62A and SDDC 34 includes resources 62B. Resources 62 may be deployed in their respective cloud by the user or deployed automatically on the user's behalf. Public cloud 26 includes a billing system 64. Public cloud 28 includes a billing system 66. Billing system 64 generates billing artifacts for resources 62A deployed in public cloud 26 for the user. Billing system 66 generates billing artifacts for resources 62B deployed in public cloud 28 for the user. Resources 62 can be any type of virtualized infrastructure, software, or the like offered by a cloud. The billing systems track the deployment of the resources by the user or on behalf of the user and generate billing artifacts detailing the cost of such deployment. G-DAS 60 collects billing artifacts from public clouds 26 and 28 for processing. The example of FIG. 1 includes two public clouds 26 and 28. It is to be understood that computing system 100 can include, in general, one or more public clouds, each generating billing artifacts that are consumed by G-DAS 60.

FIG. 2 is a block diagram depicting an SDDC 200 according to embodiments. SDDC 200 or variants thereof can be SDDC(s) 22, 30, 34. SDDC 200 includes a cluster of hosts 240 (“host cluster 218”) that may be constructed on hardware platforms such as x86 architecture platforms or ARM platforms of physical servers. For purposes of clarity, only one host cluster 218 is shown. However, SDDC 200 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 240 to communicate with other devices through a physical network 280. Physical network 280 enables communication between hosts 240 and between other components and hosts 240.

In the embodiment illustrated in FIG. 2, hosts 240 access shared storage 270 by using NICs 264 to connect to network 280. In another embodiment, each host 240 contains a host bus adapter (HBA) through which input/output operations (IOs) are sent to shared storage 270 over a separate network (e.g., a fibre channel (FC) network). Shared storage 270 include one or more storage arrays, such as a storage area network (SAN), network attached storage (NAS), or the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN, which is another form of shared storage 270.

Software 224 of each host 240 provides a virtualization layer, referred to herein as a hypervisor 228, which directly executes on hardware platform 222. In an embodiment, there is no intervening software, such as a host operating system (OS), between hypervisor 228 and hardware platform 222. Thus, hypervisor 228 is a Type-1 hypervisor (also known as a “bare-metal” hypervisor). As a result, the virtualization layer in host cluster 218 (collectively hypervisors 228) is a bare-metal virtualization layer executing directly on host hardware platforms. Hypervisor 228 abstracts processor, memory, storage, and network resources of hardware platform 222 to provide a virtual machine execution space within which multiple virtual machines (VM) 236 may be concurrently instantiated and executed. User workloads 242 execute in VMs 236 either directly on guest operating systems or using containers 238. Containers 238 implement operating system-level virtualization, wherein an abstraction layer is provided on top of a guest operating system in a VM 236. User workloads 242 comprise business applications, services, etc. deployed by the user.

The SDN of SDDC 200 includes an SDN layer 275 executing in hypervisors 228 of hosts 240. SDN layer 275 includes distributed software, such as distributed switches, distributed routers, etc. The SDN of SDDC 200 can further include virtualization software 244 executing in VM(s) 236, such as network control planes, service routers, etc. The SDN of SDDC 200 can further include edge gateways 278 that provide an interface between SDDC 200 and an external network (e.g., WAN 25). Edge gateways 278 can execute as virtualization software 244 on VM(s) or in separate hosts (not shown), which can be virtualized hosts or non-virtualized hosts.

A virtualization manager 210 manages host cluster 218 and hypervisors 228. Virtualization manager 210 installs agent(s) in hypervisor 228 to add a host 240 as a managed entity. Virtualization manager 210 logically groups hosts 240 into host cluster 218 to provide cluster-level functions to hosts 240, such as VM migration between hosts 240 (e.g., for load balancing), distributed power management, dynamic VM placement according to affinity and anti-affinity rules, and high-availability. The number of hosts 240 in host cluster 218 may be one or many. Virtualization manager 210 can manage more than one host cluster 218. SDDC 200 can include more than one virtualization manager 210, each managing one or more host clusters 218.

SDDC 200 further includes a network manager 212. Network manager 212 manages the SDN of SDDC 200. Network manager 212 installs additional agents in hypervisor 228 to add a host 240 as a managed entity. Network manager 212 provides a management plane for SDN layer 275, SDN-related virtualization software 244, and edge gateways 278. In the context of SDDCs 22, 30, and 34 shown in FIG. 1, network manager 212 is a local network manager. In embodiments, global network manager 20 executes in public cloud 10 as-a-service, e.g., as a SaaS product or laaS product. In another embodiment, global network manager 20 can be a network manager 212 of an SDDC. That is, a particular network manager 212 of an SDDC in computing system 100 can function as a global network manager and other network manager(s) 212 in other SDDC(s) can function as local network managers.

In embodiments, virtualization manager 210 and network manager 212 execute on hosts 240A, which are selected ones of hosts 240 and which form a management cluster. Virtualization manager 210 and network manager 212 can execute in VMs 236 (with or without containers 238) on hosts 240A. In other embodiments, either or both of virtualization manager 210 and network manager 212 can execute on non-virtualized physical servers having operating systems installed therein rather than hypervisors. In other embodiments, either or both of virtualization manager 210 and network manager 212 can execute in host cluster 218, rather than a separate management cluster.

Resources deployed in a public cloud can be software executing in VMs/containers. Resources can also be virtualized infrastructure, such as VMs, containers, virtualized hosts, virtualization manager 210, network manager 212, edge gateways 278, SDN layer 275, or the like.

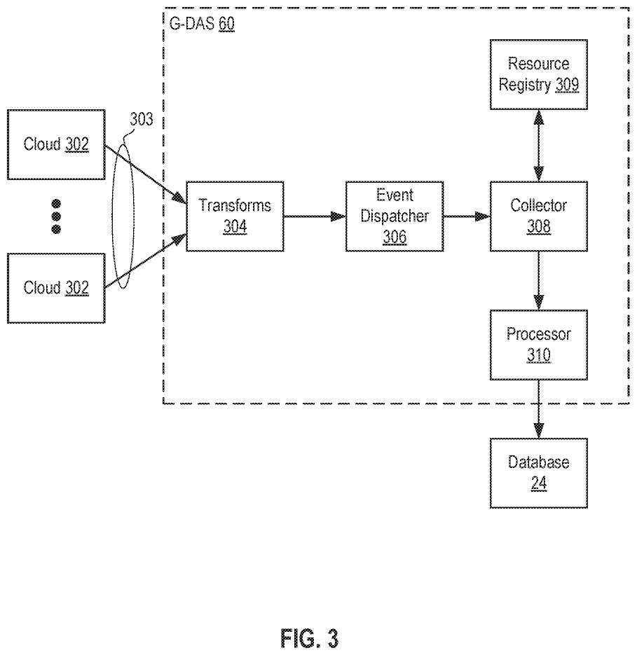

FIG. 3 is a block diagram depicting G-DAS 60 according to embodiments. G-DAS 60 includes transforms 304, event dispatcher 306, collector 308, processor 310. G-DAS 60 stores data in database 24. G-DAS 60 receives billing artifacts 303 from one or more clouds 302. Billing artifacts include data related to resources deployed in clouds 302 by the user or on the user's behalf (e.g., the cost of such resources, identification data, data related to deployment, such as times, durations, etc., and the like). G-DAS 60 collects information about resources being used in the user's cloud accounts and stores it in database 24. The stored information includes, for example, when the resources were created, region, account, most recent tags, and whether the resources are currently active or have been terminated. G-DAS 60 derives this information from billing artifacts 303 that are generated for the user's cloud accounts.

An incoming billing artifact from a cloud provider can be extremely large, which makes processing it without transformation impractical. For example, a user of a public cloud with a single billing account for a single month can receive a billing artifact that exceeds a terabyte in size. To combat the sheer size of these artifacts, G-DAS 60 performs transformations on the billing artifacts to create smaller artifacts that include only the necessary information for resource derivation (“transforms 304”).

In embodiments, transforms 304 comprise queries (e.g., APACHE SPARK queries) that execute on the billing artifacts. A billing artifact can comprise, for example a tabular set of data. An example structure of a billing artifact is shown in table 1 below.

TABLE 1

| resource_id | account_id | product_name | usage_timestamp | region | tags |
|---|---|---|---|---|---|
| resource1 | 1234 | product1 | 2023-03-26T0 1:00:00 | region1 | {} |
| resource2 | 5678 | product2 | 2023-03-26T02:00:00 | region2 | {“key1”:“value1”} |
| resource3 | 1234 | product1 | 2023-03-26T02:00:00 | region1 | {“key2”:“value2”} |
| resource4 | 5678 | product2 | 2023-03-26T03:00:00 | region2 | {“key1”:“value1”} |
| resource5 | 1234 | product1 | 2023-03-26T03:00:00 | region1 | {“key2”:“value3”} |
| resource6 | 1234 | product1 | 2023-03-26T03:00:00 | region3 | {} |

In the example, the billing artifact includes a table with entries for each resource. Each entry includes a resource ID, an account ID, a product name, a usage timestamp, a region, and optional tags associated with the resource. Those skilled in the art will appreciate that such a billing artifact is an example and different billing artifacts can include different types of information and table structures. In general, a billing artifact includes entries associated with resources, where each entry identifies a resource and includes information associated with the resource. In embodiments, billing artifacts from different clouds can include the same or similar information but arranged in different formats. For example, each tag in Table 1 above is included in one column. However, another billing artifact can include tags, but multiple tags are disposed in multiple columns.

Transforms 304 process each billing artifact to filter and transform the data into a new data set. An example structure of a transformed billing artifact is shown below in Table 2.

TABLE 2

| | | | | | | most_ | |
|---|---|---|---|---|---|---|---|
| resource_ | resource_id_ | account_ | product_ | | start_ | recent_ | |
| id | sha1 | id | name | region | time | time | tags |
| resource1 | 7617 . . . fcSc | 1234 | product1 | region1 | time1 | time3 | tag1 |
| resource2 | 9f9a . . . 581a | 1234 | product1 | region3 | time2 | time3 | tag2 |
| resource3 | c8af . . . 8dbl | 5678 | product2 | region2 | time3 | time3 | tag3 |

This example transformed artifact would be the result of performing the transform on the input artifact described in Table 1. The generated transformed artifact has the following properties: The query groups by account_id, product_name, and resource_id. This means in the output artifact there will be exactly one row per account_id, product_name, and resource_id combination. For an example cloud, the cost and usage report (CUR) is itemized per operation, per resource, and per hour. This means a single resource ID can have ˜3000 rows (31 days×24 hours×4 operations). By aggregating in this way, more than 1 terabyte CURs can be brought down to a couple gigabytes for processing by G-DAS 60. The transformed artifact is ordered by product_name and then resource_id_sha1 within each product name. This ordering allows incremental processing job fanout during the collection phase which will be explained further below.

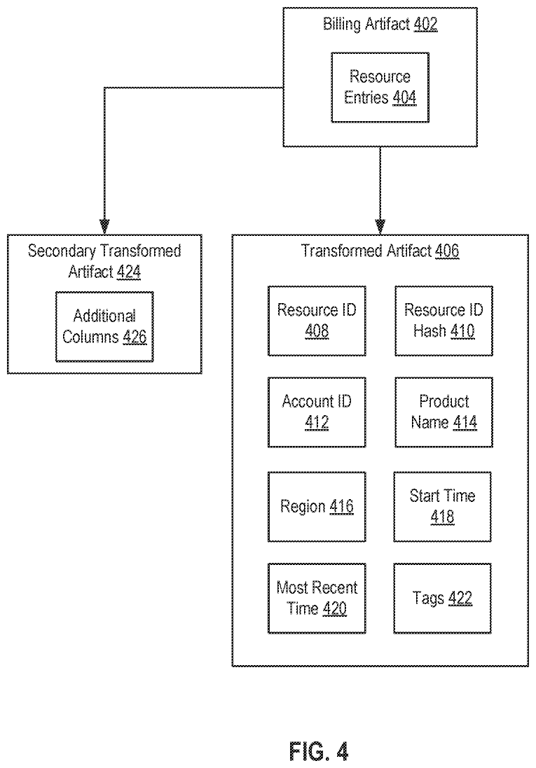

FIG. 4 is a block diagram depicting an artifact transformation according to embodiments. A billing artifact 402 includes resource entries 404. For example, each entry 404 relates a resource with various information as described above. Billing artifacts 402 from different cloud providers can have different structures. G-DAS 60 generates a transformed artifact 406. Transformed artifact 406 can be the same for each billing artifact regardless of the cloud provider. Transformed artifact 406 includes a resource ID 408, a resource ID hash 410, an account ID 412, a product name 414, a region 416, a start time 418, a most recent time, and tags 422.

Resource ID 408 is the identifier for the resource in the current row generated by the cloud provider. Resource ID hash 410 is the hash of the resource ID computed during transform. Account ID 412 is the ID of the cloud account that the resource belongs to. This can be an account ID, subscription ID, compute project ID, etc. Product name 414 is the service category for the resource belongs. Region 416 is the cloud region in which the resource belongs. Start time 418 is the earliest usage timestamp for this resource found in this billing artifact. If this is the first month this resource is seen, it is the time that the resource was created. Most recent time 420 is the most recent usage timestamp for this resource in this billing artifact. If this is the last time the resource is seen, then it is the time that the resource was inactivated. Tags 422 is the most recent set of tags that the user has attached to this resource, e.g., JSON hash in the format of {“tagkey”: “tagvalue”}.

In certain cases, it may be beneficial to split a particular resource type out of the main artifact transformation into a separate transformation. This may be due to the cloud treating certain rows differently and requiring additional filtering, or because additional information could be added to the artifact to enhance the data derived for that resource type. Since the backbone of the query is standard for all artifacts and reasonably complex, this can be abstracted into a query framework. This framework allows specifying a new transform for a given cloud's monthly billing artifact with any additional logic built on top. This allows additional custom columns on a per-resource-type basis which will be used in processing to populate additional fields in the database model. This prevents adding columns to the primary artifact for all resource types which would be empty/ignored for the rest of the resource types. As shown in FIG. 4, in an embodiment, G-DAS 60 generates a secondary transformed artifact 406 for those billing artifacts from a certain cloud provider. Secondary transformed artifact 406 includes additional columns 426 not present in transformed artifact 406 and that are relevant to a particular cloud provider.

Returning to FIG. 3, event dispatcher 306 receives the artifact transformations from transforms 304. Event dispatcher 306 can perform validation of the artifact transformations and queues the artifact transformations for processing be collector 308.

Collector 308 is responsible for scanning the transformed artifacts and generating processing jobs for consumption by processor 310. In order for a resource type to be derived by G-DAS 60, it must have an entry in resource registry 309. This registration provides all of the information required to derive the resource type. This includes, for example, the following information: (1) Product—the service category that resource falls under in the bill. (May be more than one in certain cases); (2) Resource ID pattern—A regex that matches the resource ID format for this resource type. This regex in conjunction with the product field determines whether a given resource belongs to this resource type; (3) Cloud—the cloud to which this resource belongs; (4) G-DAS artifact name—A given resource type can only be derived from exactly one G-DAS artifact type. This specifies which artifact type this resource type should be derived from. (5) Job partition column—The column containing the values that should be used to partition processing jobs (e.g., resource_id_sha1); (6) Partition minimum value-minimum value of the partition field; (7) Partition maximum value-maximum value of the partition field.

When collector 308 picks up a job from the collection queue, it first builds a lookup of all of the registered resource types that are configured to be derived from the artifact being processed. Collector 308 then streams the artifact and filters out any rows that have a product name that does not belong to any of the registered resource types for this artifact.

As the billing artifact rows are being iterated over, collector 308 is categorizing resources in order to generate properly scoped processing jobs. Processing jobs are scoped by cloud account and resource type. On top of that, each processing job has a maximum size in terms of number of resources. Having fixed-size processing jobs has several benefits: Smaller job sizes limit the blast radius of job failures. No arbitrarily large jobs. Some users use more than 10,000,000 resources in a single month. This can be too many resources to process in a single job. Payload, caches, and memory usage would be enormous. Smaller job sizes improves the ability to parallelize work in processor 310.

As discussed above with respect to transformation, the artifact being processed in this stage is ordered by product_name and resource_id_sha1. This means that processing jobs can be posted before waiting until the entire artifact is processed. As the rows of the billing artifact are iterated over, as soon as threshold number of resources are collected for an account and resource type, that job can be posted to the processing queue and that data can be deleted from memory. In addition, once a new product is reached while iterating, the remaining resources can be flushed into processing jobs and out of memory because it is guaranteed that no more resources for that resource type will be seen in the remainder of the artifact. This greatly reduces the total memory usage of collector 308 by only needing to hold a small subset of the resource data in memory at any one point in time.

Processor 310 is responsible for creating, updating, and persisting resources into database 24. Processor 310 performs each processing job generated by collector 308. Processor 310 updates database 24 to store cloud resources and associated information derived from the billing artifacts as discussed above.

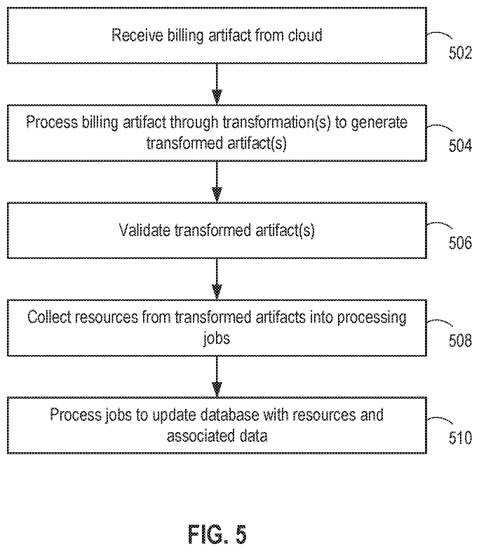

FIG. 5 is a flow diagram depicting a method 500 of deriving resources and resource utilization from billing artifacts from clouds according to embodiments. Method 500 begins at step 502, where G-DAS 60 receives a billing artifact from a cloud. At step 504, G-DAS 60 processes the billing artifact through one or more transformations to generate one or more transformed artifacts. At step 506, G-DAS 60 validates the transformed artifacts. At step 508, G-DAS 60 collects resources from the transformed artifacts into processing jobs. At step 510, G-DAS 60 processes the jobs to update the database with resources and associated resource data.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in userspace on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. In some cases, if and where relevant, “virtualized computing instance” can encompass both VMs and containers.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of identifying resources deployed in clouds in a computing system, comprising:
receiving, at an asset scanner executing in a data center, billing artifacts from the clouds, the billing artifacts relating resources deployed in the clouds with identification and usage information;
transforming, by the asset scanner, the billing artifacts into transformed billing artifacts, each transformed billing artifact having entries that relate one of the resources to a selected portion of the identification and usage information;
generating, by the asset scanner, a plurality of jobs to process the resources; and
processing, by the asset scanner, the plurality of jobs to update a database that relates the resources and the selected portion of the identification and usage information.

2. The method of claim 1, wherein the billing artifacts have different structures among the clouds.

3. The method of claim 1, wherein the transformed billing artifacts are common among the clouds.

4. The method of claim 1, wherein the asset scanner is configured to generate, for a first billing artifact from a first cloud, a first transformed billing artifact having a plurality of columns that are common among all of the transformed billing artifacts.

5. The method of claim 4, wherein the asset scanner is configured to generate, from the first billing artifact, a second transformed billing artifact having at least on additional column that is unique to the first cloud.

6. The method of claim 1, wherein the step of generating the plurality of jobs comprises:
identifying, by the asset scanner, a set of resources to be derived in a resource registry; and
scanning, by the asset scanner, the transformed billing artifacts for resources that match the set of resources to be derived.

7. The method of claim 6, wherein the asset scanner is configured to filter out from the transformed artifacts those of the resources that do not match the set of resources to be derived in the resource registry.

8. A non-transitory computer readable medium comprising instructions to be executed in a computing device to cause the computing device to carry out a method of identifying resources deployed in clouds in a computing system, comprising:
receiving, at an asset scanner executing in a data center, billing artifacts from the clouds, the billing artifacts relating resources deployed in the clouds with identification and usage information;
transforming, by the asset scanner, the billing artifacts into transformed billing artifacts, each transformed billing artifact having entries that relate one of the resources to a selected portion of the identification and usage information;
generating, by the asset scanner, a plurality of jobs to process the resources; and
processing, by the asset scanner, the plurality of jobs to update a database that relates the resources and the selected portion of the identification and usage information.

9. The non-transitory computer readable medium of claim 8, wherein the billing artifacts have different structures among the clouds.

10. The non-transitory computer readable medium of claim 8, wherein the transformed billing artifacts are common among the clouds.

11. The non-transitory computer readable medium of claim 8, wherein the asset scanner is configured to generate, for a first billing artifact from a first cloud, a first transformed billing artifact having a plurality of columns that are common among all of the transformed billing artifacts.

12. The non-transitory computer readable medium of claim 11, wherein the asset scanner is configured to generate, from the first billing artifact, a second transformed billing artifact having at least on additional column that is unique to the first cloud.

13. The non-transitory computer readable medium of claim 8, wherein the step of generating the plurality of jobs comprises:
identifying, by the asset scanner, a set of resources to be derived in a resource registry; and
scanning, by the asset scanner, the transformed billing artifacts for resources that match the set of resources to be derived.

14. The non-transitory computer readable medium of claim 13, wherein the asset scanner is configured to filter out from the transformed artifacts those of the resources that do not match the set of resources to be derived in the resource registry.

15. A computing system, comprising:
a plurality of clouds having resources deployed therein;
a data center executing an asset scanner, the asset scanner configured to:
receive billing artifacts from the clouds, the billing artifacts relating the resources deployed in the clouds with identification and usage information;
transform the billing artifacts into transformed billing artifacts, each transformed billing artifact having entries that relate one of the resources to a selected portion of the identification and usage information;
generate a plurality of jobs to process the resources; and
process the plurality of jobs to update a database that relates the resources and the selected portion of the identification and usage information.

16. The computing system of claim 15, wherein the billing artifacts have different structures among the clouds.

17. The computing system of claim 15, wherein the transformed billing artifacts are common among the clouds.

18. The computing system of claim 15, wherein the asset scanner is configured to generate, for a first billing artifact from a first cloud, a first transformed billing artifact having a plurality of columns that are common among all of the transformed billing artifacts.

19. The computing system of claim 18, wherein the asset scanner is configured to generate, from the first billing artifact, a second transformed billing artifact having at least on additional column that is unique to the first cloud.

20. The computing system of claim 15, wherein the step of generating the plurality of jobs comprises:
identifying, by the asset scanner, a set of resources to be derived in a resource registry; and
scanning, by the asset scanner, the transformed billing artifacts for resources that match the set of resources to be derived.
